(19) United States
(12) Patent Application Publication
(10) Pub. No.: US 2006/0251787 A1
(43) Pub. Date: Nov. 9, 2006

(54) Nutritional product and hydration method of manufacture

(76) Inventor: Michael G. Angel, Winchester, CA (US)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/123,472

(22) Filed: May 5, 2005

(51) Int. Cl. A21D 10/00

(52) U.S. Cl. 426/549

(57) ABSTRACT

A food product and method of making it in is provided in which the product includes a hydrated and then frozen plurality of grain or seed based constituents. In a preferred embodiment the product can be prepared by selecting one or more grain or seed based constituents, hydrating to a desired softness, then packaging and freezing.

### FIELD OF THE INVENTION

The present invention relates to a grain or seed food product that is manufactured using hydration and/or freezing, and to a food product prepared for consumption by thawing. The food product optionally is a time released nutritional product containing components that are digested at different rates providing nutritional value over relatively short, medium and long periods of time.

### BACKGROUND OF THE INVENTION

Various types of ready-to-eat and cooked cereal products are known. For example, various processed cereal products are known. Such cereal products frequently are made of uniformly processed grains that typically include a processed flour form, which is formed into a desired shape, and baked, toasted or otherwise pre-prepared. Various additives such as sugar or dried fruits are added. Among such processed cereal food products are “Cheereos” or “Wheaties” from General Mills Corp., located in Minneapolis, Minn.

Various forms of cereal products to be cooked are also known. One example is oatmeal, which typically includes a dry form of rolled oats, which is prepared by adding water and then boiled for a period of time until a desired consistency is achieved. One example of an oatmeal product is “Quaker Oats” available from The Quaker Oats Company, Chicago, Ill. Cereal products such as this that are available in a dry form and meant to be cooked will be referred to herein as “cooked cereal” products.

Some ready-to-eat and cooked cereal products have a disadvantage in that the product is digested over a relatively short period of time. For examples cereal products made of a grain or grains that is/are processed in a single way tends to be digested within a given time period. Easy to digest flour based products can typically be digested over a relatively short period of time. With such a product one tends to get hungry relatively quickly after eating. Various known ready-to-eat and cooked cereal products suffer this disadvantage.

One known cereal product directed to providing a longer period of digestion is described in U.S. Pat. No. 5,759,612. The product is meant to be digested over an extended period of time providing for the release of energy over an extended period of time. Components of varying levels of fiber and degree of cook are selected. However, this product suffers a number of disadvantages, including that preparation requires several different cooking steps under different preparation conditions, such as preparing different components in separate batches.

De-hulled whole grain oats, known as groats, have various known nutritional benefits including high fiber, and relatively slow digestion times. Likewise bumped oat groats, which are lightly processed groats have relatively slow digestion times. Other forms of oats, such as cut oats also have some of these benefits, but a generally faster digestion time than groats, but still slower than rolled oats. One disadvantage of a cooked or liquid cereal product including groats, bumped oats, or cut oats is that a relatively long cooking time is required in order to soften the groats sufficiently to be swallowed with ease. Without sufficient softening, the groat or steel cut oat can remain relatively hard and undesirable for human consumption.

Hot grain cereals on the market today typically provide only one milling process (i.e. rolling) and therefore a uniform digestion process that does not regulate carbohydrate or other nutrition delivery times, nor do they typically provide different grain milling types that have different digesting times and carbohydrate delivery.

In addition hot grain cereals are not known to provide fresh fruit or frozen fruit, unless added by the consumer prior to eating.

In addition, intact whole grain (i.e. with or without hulls, but including the testa or seed coating) is considered to provide health benefits, such as including naturally occurring nutrients and phytochmicals. However, the above-discussed products suffer a disadvantage in that they typically cannot make use of whole unprocessed grains, which are viewed as not susceptible of inclusion in a commercial product, without at least some processing.

It is understood that the high and frequent pervasive consumption of high glycemic index foods in common modern diets can result in various health problems, such as obesity and type 2 diabetes. Furthermore, high-glycemic index diets result in high levels of insulin, which increase hunger and favor fat deposition. Staving off a hungry feeling is understood to be one reason for obesity, in which a hungry feeling results in further food consumption. Low satiety occurring with high-glycemic index foods translates into significantly increased food and calorie consumption leading to weight gain in many people. Satiety is a function several food attributes: the glycemic index, level of dietary fiber, starch resistance, digestion time, and carbohydrate availability or delivery.

Various methods of manufacture or preparation of grain or seed based food products are known. In one method of manufacture warm breakfast cereals are manufactured by packaging grains or seeds (or other additives) in containers for distribution to consumers. The consumer prepares the cereal by adding a fluid such as water and/or milk and accelerating the fluid infiltration of the cereal constituents by application of heat for a designated period of time. In one known method, water is measured and mixed with the product and boiled for a designated period of time. In another known method a consumer positions the product in already boiling water. In another known method the product is mixed with water in a bowl and microwave heated for a period of time. These methods suffer various disadvantages, including requiring the application of heat to assist with fluid infiltration and resultant increased energy costs and risk of injury from handling boiling water. Other disadvantages are involved in the increased requirements of handling, such as in measuring the fluid, adding it in, and positioning the combination in a microwave or on a stove.

In another method of manufacture, the grain or seed based food product is freeze dried in manufacture. The consumer re-hydrates the product for consumption. This technique also suffers disadvantages of involving increased manufacturing expense in the freeze-drying process. Preparation also has the disadvantage of involving adding in a fluid for re-hydration.

Further disadvantages of hot cereals or hot soup products is that nutrient loss or particle breakdowns can occur during the cooking process. Other disadvantages of known products is that a single serving generally does not meet recommended levels of fruit and whole grain, such as recommended in the FDA food pyramid recommendations.

Accordingly, there exists a need for a liquid or cooked food product that can be prepared without the addition of a fluid by the consumer in preparation and/or without enhanced fluid infiltration, nutrient losses or particle breakdowns by way of the application of heat in cooking. There also exists a need for a frozen food product that provides in a single serving recommended levels of fruit and whole grains.

### SUMMARY OF THE INVENTION

The present invention alleviates to a great extent the disadvantages of known cereal and grain or seed products by providing a pre-hydrated cereal or grain and/or seed product that can be prepared by the consumer such as by opening a container or by heating to a desired temperature. In fabrication, the grain and/or seed constituents preferably are hydrated by positioning the constituents in a fluid bath for a desired period of time, and then packaging the product for shipment, such as by freezing. Optionally, the product can be heated and stored in a vacuum-sealed container and thereby be packaged in a fluidized state. A consumer can open the container, and in the frozen embodiment thaw prior to consumption. Optionally, the consumer can thaw by applying heat from an external source and optionally raise the temperature to an elevated level to have a “hot” cereal for consumption.

In a preferred embodiment, the food product is a time released nutritional product that includes a plurality of grain or seed based constituents having plural digestion rates, such as described in U.S. patent application Ser. No. 10/457,089, entitled “Time Released Nutritional Product and Method of Manufacture”, and in U.S. patent application Ser. No. 11/063,390, entitled “Time Released Nutritional Product and Method Of Manufacture”, the contents of both of which are incorporated herein by reference. In an alternative embodiment, one or more grain constituents and/or seed constituents of similar digestion rates are used, or alternatively are combined with other grains and/or seeds of differing digestion rates. In any of the embodiments, other constituents can be included such as fruits, sugars, syrup etc.

In an embodiment, differing percentages of constituent parts are provided. The constituent parts may be one or more grain (or other type of seed) processed in one or more ways. As one example, one such food product includes different forms of oats combined together, such as part groats and/or part bumped groats and/or part steel cut oats and/or part rolled oats. It should be noted that each milling process can vary as well. For example in the bumped groats, differing degrees of bump can be selected. Likewise in the rolled oats, differing rolling distances can be selected. The different constituent parts are selected to provide particular ranges of digestion or nutrition delivery rates.

In one example, the constituent parts include oats processed by a combination of three different ways: rolled (a flake product of selected thicknesses distances), steel cut (slices of whole grains of selected slice sizes), bumped groats and groats (de-hulled whole grain oats). Percentages of each of the three different processed oat products are combined. Rolled oats are digested relatively quickly providing relatively quick energy and nutrition delivery, steel cut oats are digested at a relatively slower rate, over a medium length of time, bumped groats and groats are digested a still longer period of time thus providing extended nutrition and energy delivery. Whole grains can be used as well.

In manufacture of a preferred food product, fluid, such as water or other hydrating fluid such as milk or various combinations of milk, water and/or juices are combined with the dry constituents. The mixture is allowed to hydrate for a period of time and other constituents can be added as well, such as honey, powdered milk, soy products, fruit (for examples strawberries, blueberries, cranberries, citrus etc., or combinations thereof). These added constituents can be added at any desired stage before, during or after hydration. The hydrated product then optionally is frozen or packaged and subsequently frozen. In an embodiment in which fresh fruit or fresh frozen fruit is added following hydration (i.e. after or at the end of the hydration period), fresh frozen fruit is provided to the consumer. For consumption, the consumer thaws the product prior to eating, optionally with the aid of applied heat, such as via a microwave.

It should be noted that in other embodiments, various combinations of other grains or seeds can be used, such as wheat, corn, barley, flax, maize etc. various combinations of processing methods are used. In another embodiment, cooking or partial cooking of the grain constituents is performed instead of or in addition to hydration. This can serve to decrease the hydration period. In addition, fresh fruit or fresh frozen fruit can be added prior to freezing creating a frozen food product containing fruit and in one alternative, which meets the FDA recommendations for fruit and whole grains in a single serving.

In other embodiments, a hot or liquid food product is provided in which the product is heated following packaging. In one example a soup product is heated. In another a hot cereal product is provided. In one embodiment, a period of time is selected for the heating of products containing a grain, in which loose starch particles form a gelatinous composition coating the pieces of the other constituents, rendering them more swallowable than they otherwise would be.

Besides cereal mixtures, other forms of time released food products and carbohydrate delivery systems are provided in accordance with the present invention. For example, soups, pre-prepared hot breakfast cereals, food additives to other foods, cookies and energy/nutrition bars can be prepared in accordance with the invention. In another example, the food product is prepared and then stored for consumption at a later time, such as by being freeze dried or otherwise dehydrated after hydration. In this way, the food product can be packaged or otherwise stored in the dehydrated form for consumption at a later time in which it can be rapidly re-hydrated for consumption by adding fluid and optionally heating. Advantageously, for grain based embodiments of the food product, the particle size is relatively large such as compared to instant grain cereals, so it is possible to freeze dry (or dehydrate) the food product and subsequently reconstitute it and maintain particle integrity, and a relatively low glycemic index. In some embodiments, the food composition of the present invention can be used to provide a time released or otherwise regulated delivery of nutritional elements for uses as a diabetes treatment, for uses in dieting and in treatment of obesity.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is flowchart illustrating a method of making a food product in accordance with the present invention;

FIG. 2 is flowchart illustrating a method of preparing a food product for consumption in accordance with the present invention;

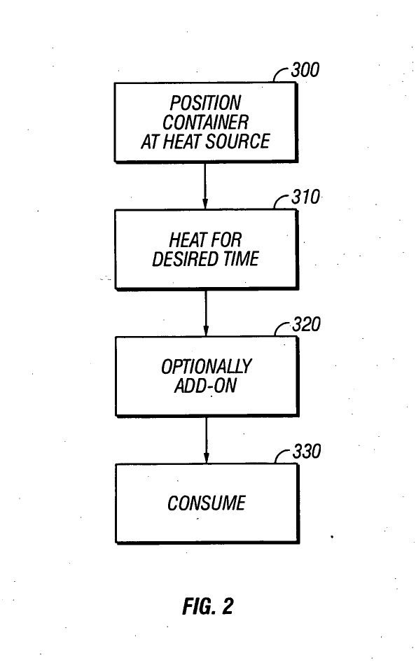

FIG. 3 is flowchart illustrating a method of making a food product in accordance with the present invention;

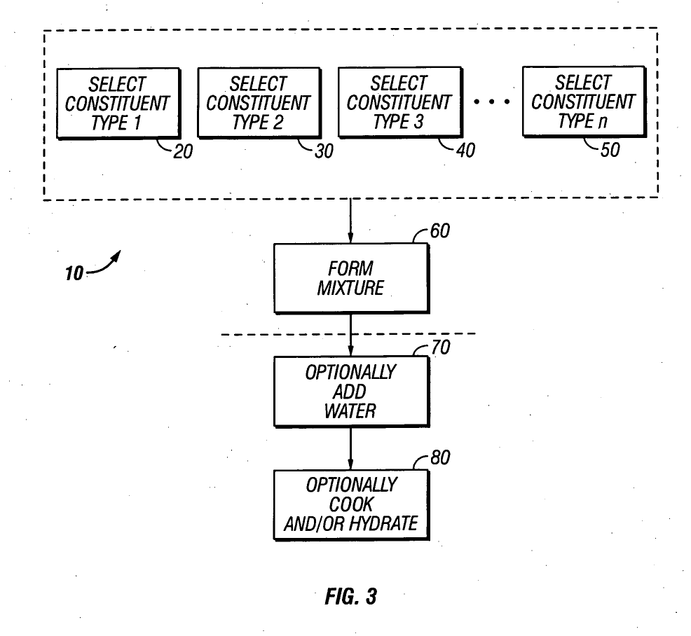

FIG. 4 is flowchart illustrating a method of making a food product in accordance with another embodiment of the present invention;

FIG. 5 is flowchart illustrating a method of making a food product in accordance with the present invention;

FIG. 6 is flowchart illustrating a method of making a packaged food product in accordance with another embodiment of the present invention;

FIG. 7 is flowchart illustrating a method of making a packaged food product in accordance with another embodiment of the present invention; and

FIG. 8 is flowchart illustrating a method of making a packaged food product in accordance with another embodiment of the present invention.

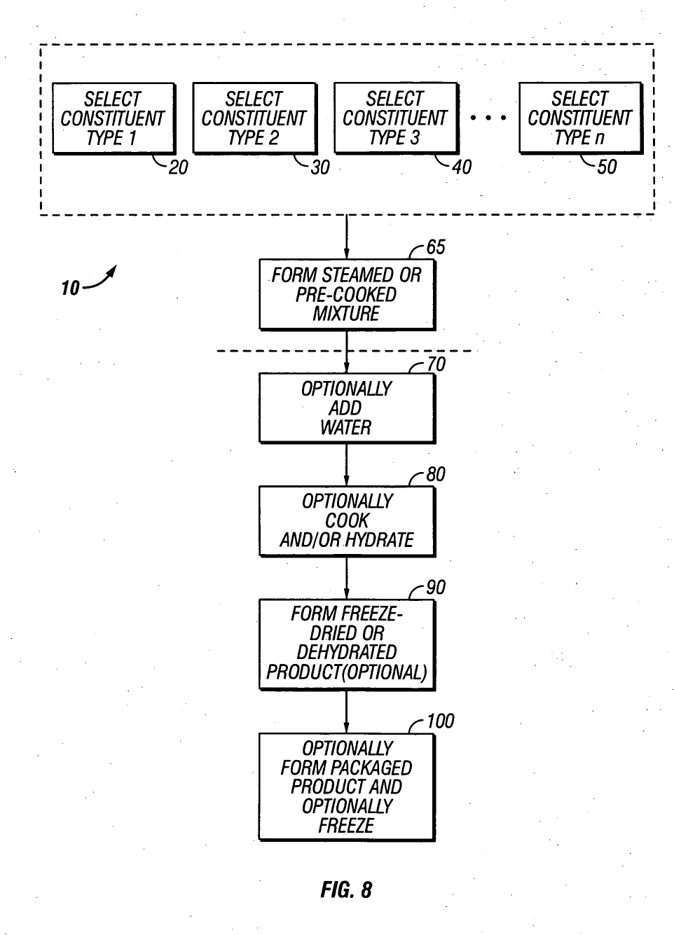

### DETAILED DESCRIPTION OF THE PREFERRED EMBODIMENTS

In the following paragraphs, the present invention will be described in detail by way of example with reference to the attached drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The terms “food product” and “food composition” of the present invention refer to an embodiment of the present invention suitable for consumption by a consumer, either with further preparation such as by cooking, heating or thawing, or without further preparation, although it should be understood that other embodiments of the present invention are in cooked or liquid form. The terms “food product” and “food composition” also refer to any end product including without limitation hydrated and frozen food products including or not including fresh frozen fruit, cereal constituents and frozen soups ready for consumption or heating.

Broadly speaking, in a preferred embodiment, the food product comprises a combination or mixture of a plurality of grain or seed based constituents having plural digestion or nutrition time release rates. However, it should be understood that in alternate embodiments, a single type of grain or seed based constituent is selected with one or more digestion or nutrient time release rate, or multiple grain or seed based constituents are selected with substantially similar digestion or nutrient time release rates. Although it is preferred that grains or seed be among the constituent ingredients, it is not required that they be included.

Following selection of the basic ingredients, the constituents preferably are hydrated and optionally other constituents are added either before, during or after hydration. The hydrated composition then is frozen prior to distribution or shipment to consumers.

By digestion or nutrition time release rates what is meant is that after eating, the nutritional elements are made available to the human body. Thus, in an embodiment including different types of grains or different preparations of grains, the different constituent parts provide plural time ranges in which the nutritional elements, for example carbohydrates are absorbed from the digestive tract thereby becoming available to the body. In one embodiment, the constituents include combinations of one or more grains or other seeds (or other constituents such as dried fruit), each processed or milled in one or more different processes yielding a food product having components with varying rates of digestion.

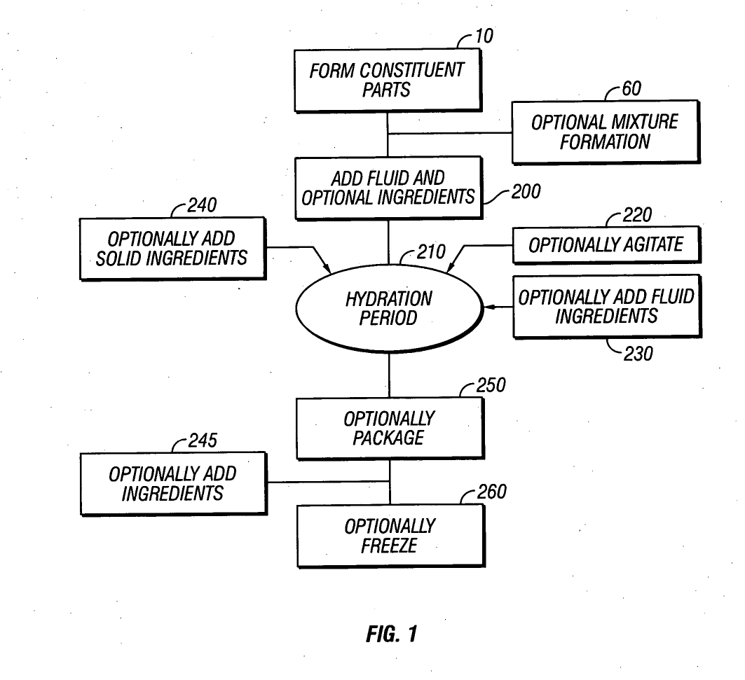

FIG. 1 provides a generalized description of a preferred method of manufacture. In the box identified with reference number 10, the types of constituents are selected. This includes selecting among different types of grains or seeds, such as for example, oats, rye, wheat, spelt, corn, flax, barley, etc. In an alternative embodiment, the constituents can include other types of food products, such as dried fruit, nuts, chocolate, etc. In addition different forms of processing for the selected grains and seeds are selected in step 10. For example, ground flour, rolled, cut, bumped groats, kernel, whole grain or otherwise milled or physically modified grains and seeds. It should be noted that each of these processes can be selected with particular parameter producing different constituent parts. For example, rolled grains can be produced at different roller separation settings yielding different width (i.e. thickness) flakes. Likewise, cut grains can be created with different width of cuts. Preferably the grains or seeds and processings are selected to achieve a cereal having constituents of differing digestion or nutrition release rates. In an alternate embodiment, either a single constituent is selected or multiple constituents are selected with similar digestion or nutrition delivery rates.

Preferably, one or more constituents are selected, which when hydrated or cooked soften the grain or seed constituents. The constituents can form a gelatinous composition that can coat one or more other constituents by making use of loose starch particles, such as when cooked by a consumer, if heating is desired, or during manufacture, if cooking or pre-cooking is performed as a part of the hydration step. So in this embodiment, the food product includes a plurality of constituents having more than one digestion, energy or nutrition delivery rates, and optionally includes a starch composition coating at least a portion of at least one of the constituent parts.

In an alternative, grain or seed constituents, including pre-processed flakes can be coated other than by gelatinous composition, such as by other relatively water impermeable or low permeability edible coating materials. In this way, the constituent parts are rendered more amenable for freezing, without necessarily being cooked or hydrated. In this way processed cereal flakes or other constituents can be included in or can be the major part of the frozen food product of the present invention. Likewise various combinations of grain and fruit combinations are envisioned as embodiments.

Selections of different constituents 10 are diagrammatically illustrated with the boxes identified with reference numerals 20, 30, 40 and 50, in which constituent 1, constituent 2, constituent 3 through constituent “n” are selected. Likewise, the percentages of each constituent are selected. In one example, only oats are selected as the grain and different forms of oats are used as the constituent parts. 1-99% rolled oats are selected, 1-95% groats are selected and 1-95% steel cut oats are selected. In another example groats and two types of rolled oats are selected as three constituents. In this example, the rolled oats are split among one or more roller separation settings producing different width flakes. In another example, 1-90% ground wheat is selected, 1-99% rolled oats is selected. Thus it is seen that “n” can be any number over two as the number of constituent parts required to make a mixture and any percentages may be selected such that desired varied rates of absorption, time release or digestion are provided and also preferably that at least one of the constituents when cooked can form a gelatinous composition. It should be understood that although constituents may be selected before a hydration period 210, it is not required that all of the constituents be hydrated. For example, fresh frozen fruit, chocolate, some nuts etc. are not required to be hydrated, and can be added at the end of or following hydration 210.

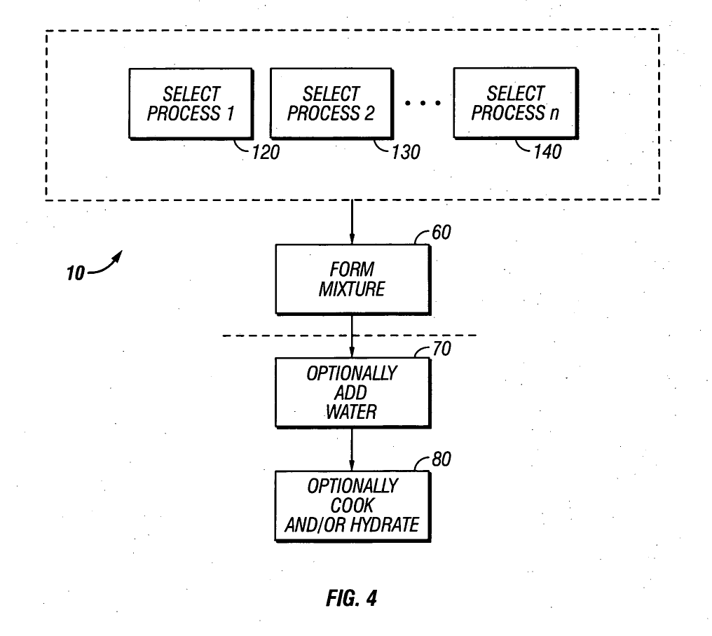

FIG. 4 illustrates an embodiment in which varied processes of manufacture of the grain constituents are selected in step 10. In box 120, process 1 is selected, in box 130, process 2 is selected and in box 140, process “m” is selected, in which “m” can be any number, including one or higher. For example if different grains are used, only a single processing step may be used. Alternatively, numerous different processes may be selected. In one alternative embodiment, the processing is performed, although pre-processed grains can be selected. It should be noted that any type of process can be selected suitable for the grain or seed, or alternatively no processing can be selected. For example, no processing would mean a whole grain or seed is selected for one of the constituent parts. So in this example, for instance, in one of steps 120, 130 or 140, no processing is selected as a “process”.

Following selection of the constituent parts and optionally percentages, a mixture is formed in step 60. It should be noted that forming a mixture also can be included in the step of forming constituent parts 10, and box 60 is used to diagrammatically illustrate this step that inherently may be performed as a part of step 10 as illustrated in FIG. 1. Accordingly, in FIG. 1, box 10 optionally includes mixing them into a mixture, which is preferred. It is not necessary to stir the constituent parts to form a uniform mixture, but doing so is preferred to provide some uniformity when portions are prepared. However, it should be noted that the constituent parts optionally can be mixed or otherwise agitated during hydration period 210 or while adding fluid 200 or adding fluid and optional ingredients. The constituent parts also can include partially cooked or fully cooked grain or seed constituents.

Following formation of the constituent parts 10, fluid is added as illustrated with box 200. The fluid preferably is water, but other fluids or combinations of fluids, such as milk, juice, honey, etc. can be provided. Different fluids, or additional amounts of fluids added in 200, can be added at other times, such as during the hydration period or afterwards. Box 200 is meant to illustrate the addition of fluids at any of these times. Optional ingredients also can be added at this stage, such as fruits and sugars. Then the fluid/constituent parts combination is set for a period of time, called the hydration period 210. It is preferred that the amount of time allocated to the hydration period be any length of time necessary to hydrate the constituent parts a desired amount. If less hydration is desired a shorter period can be selected. If more hydration or softness is desired then a longer period can be selected. Generally speaking the hydration period selected is between 5 and 15 hours and a preferred range is 10 to 12 hours or 9 to 13 hours, although short or longer periods can be selected depending on the amount of hydration desired and the particular constituents selected. It is not required to cook or heat during this period and room temperature processing is preferred. However, it should be understood that the hydration period can optionally be shortened by performing it at elevated temperatures. Any length of hydration period can be selected that achieves desired properties of the constituent parts, such as a desired softness or starch release level. Generally speaking it is preferred that the food composition have a palatable and digestable texture appealing to consumers following the hydration period 210.

During the hydration period 210, optionally the constituent parts are mixed or otherwise agitated as illustrated in box 220. The term “agitation” should be understood to include mixing, turning, tumbling or vibrating. It can involve steady agitation, or alternatively one or more periods of agitation followed by rest. Optionally there is no agitation and the constituent parts are mixed in dry form as illustrated with box 60. In another alternative, there is both mixing of the dry constituent parts 60 and agitation 220 during the hydration period.

Another option during the hydration period is to add additional fluid ingredients 230. For example, additional water might be added. In another example milk, juice, chocolate, syrup, vanilla or fruit flavorings could be added. In another example, honey is added. These additional ingredients can be added at the same or different times during hydration 210 or alternatively before or after the hydration period 210.

A further option during the hydration period is to add solid ingredients 240, such as fruit, nuts, etc. Examples of suitable solid additions include strawberries, raspberries, blueberries, peaches, cherries, oranges, other citrus, mixed fruits and/or berries, raisins, crushed cookies or candy bars, chocolate pieces, candy pieces (such as M&M's®), other solid fruit flavorings, etc. It should be noted that these additions can be added singularly or in combinations. They can be added at the same or different times during hydration 210 or alternatively before or after the hydration period 210. It should be noted that it is preferred that in embodiments in which solid or liquid ingredients are optionally added during hydration, that agitation 220 also be performed. Where adding ingredients is discussed in this description it should be understood that they optionally can be mixed in by agitation (including mixing, turning, tumbling etc.) as discussed above.

Although it generally preferred that hydration be performed at room temperature, there are alternative embodiments as well. For example, partial cooking can be performed to partially cook some or all of the constituents. The partial cooking can be performed by heating or steaming.

At the end of hydration, either following the hydration period or around the end of the period, solid or fluid ingredients also can be added, as discussed already. This is diagrammatically illustrated with box 245 showing an input between hydration 210 and packaging 250.

Following hydration, the manufactured food product preferably is frozen 260 and subsequently distributed. The product can be frozen in bulk containers for subsequent dividing. Preferably packaging 250 occurs prior to freezing 260. The packages preferably are individual or multiple serving containers, which optionally can be microwaved for consumer preparation. Any type of container can be used such as cups, sealable or resealable cups, bowls, plastic enclosures/bags, metal containers, etc. In a preferred embodiment, a plastic container is selected for packaging 250, and subsequent freezing 260. It should be noted that additional ingredients could be added prior to sealing the package, but after the hydrated mixture has been positioned within the package, including the solid and liquid additional ingredients discussed above.

In one embodiment, the hydrated mixture is put in approximately half-pint individual size plastic containers, with lids in the packaging step 250. Optionally a plastic film is applied above the opening of the container and below the plastic lid, forming a sealed enclosure, although in some embodiments, the plastic film is not used. Other size plastic containers also can be used, such as 4, 6, 10, 12 and 16 ounce containers. An advantage of such frozen plastic containers is that they are easily shipped to distribution points and ultimately retailers and consumers although other forms of containers also have such advantages.

In the frozen embodiment a consumer thaws the frozen product pior to consumption or optionally consumes in a semi-thawed state in which sufficient thawing allows for consuming bite size portions, such as with a spoon. Optionally, the consumer can thaw by applying heat from an external source and optionally raise the temperature to an elevated level to have a “hot” cereal for consumption.

In one example, a consumer of the food product positions the frozen food product at a heat source 300. In one example, the food product is positioned in a microwave, although stove heating also can be selected. Then the consumer heats the product for a desired period of time 310, such as by running the microwave. This serves to thaw the product for consumption. Optionally it is heated to an elevated temperature to produce a hot food eating experience. Depending on the temperature and time of heating, gelatinization also can occur if desired, wherein starch particles gelatinize to form a gelatinous composition. Following thawing (or heating to elevated temperature), the previously frozen product is ready for consumption 330. Optionally an add-on, such as sweetener, nuts, fruit etc. can be added 320.

As described above a frozen food product is formed including at least one hydrated constituent part that is packaged and frozen prior to thawing and consumption. The frozen food product optionally includes plural hydrated constituent parts also optionally having different or similar digestion rates or rates of nutrition delivery, making a form of time released frozen food product.

Alternatively, freezing is not performed and the package is sealed in an air-tight fashion not requiring freezing. In this alternative embodiment, the product optionally is heated and stored in an air-tight container and thereby be packaged in a fluidized state. A consumer can open the container for consuming. In embodiments, where the food product is not frozen, the food product can be packaged in any desired way for distribution to consumers. For example it can be packaged in cartons or polymeric bags or wax coated paper bags etc. Alternatively it can be packaged for bulk purchase by consumers such as in a container from which a consumer can spoon out a desired amount. Alternatively it is not packaged, but is mixed and then prepared for eating.

Optional step 70 is provided as an illustration of a preparation step of a food product in accordance with the present invention that has not been fully hydrated in the hydration period. It should be noted that only partial hydration might be performed in the hydration period in one embodiment. In that step water preferably is added in a desired proportion, and then in optional step 80 the food product is prepared for eating in some fashion. In one embodiment, step 80 is the hydration step and in others it is a heating step in which the mixture (either alone or in combination with water added in step 70) is elevated over boiling point for a period of time. It should be noted that in one or more of steps 70 and 80 or additional processing steps, other types of processing can be performed, such as to create or package cookies, nutrition or energy bars, cakes, pastries etc. In this embodiment, instead of cooking following addition of water 70, the product can be hydrated and frozen as illustrated in FIG. 1.

Other examples of the constituents (illustrated diagrammatically with reference numbers 20, 30, 40 and 50) include one or more steamed and/or pre-cooked versions of the constituents selected. For example, where the constituents are steamed and/or pre-cooked versions of the desired materials, the preparation time can be reduced. In one example, hydration time is reduced. In an alternative, after a mixture is formed (such as illustrated with reference number 60), the mixture can be steamed and/or pre-cooked and then hydrated and frozen.

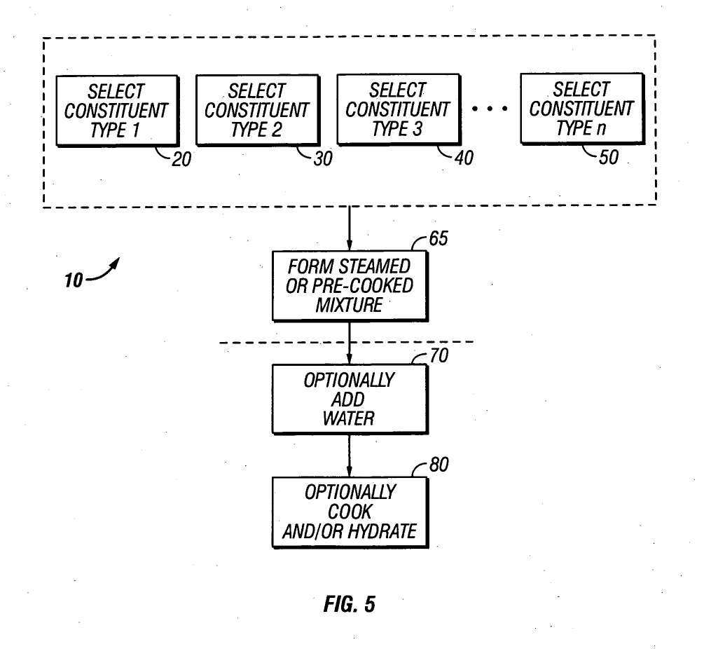

In FIG. 5, the steamed and/or pre-cooked mixture is illustrated with reference number 65. The steamed or pre-cooked mixture is formed, either by combining one or more steamed and/or pre-cooked constituents, as represented by reference number 20, 30, 40 and 50, or optionally selecting constituents that have not been steamed and/or pre-cooked, forming mixture 60, and then steaming and/or otherwise pre-cooking the mixture, as also illustrated with reference number 65.

In another embodiment, the food product is prepared as illustrated with reference to FIG. 1 and then stored for consumption at a later time, such as by being freeze dried or otherwise dehydrated after hydration (or full or partial cooking). In this way, the food product can be packaged or otherwise stored in the dehydrated form for consumption at a later time in which it can be rapidly re-hydrated for consumption by adding fluid and optionally heating. It should be noted that the freeze drying or dehydration can be performed either after full cooking 80 or hydration 200 or after the steamed or pre-cooked mixture 65 is formed.

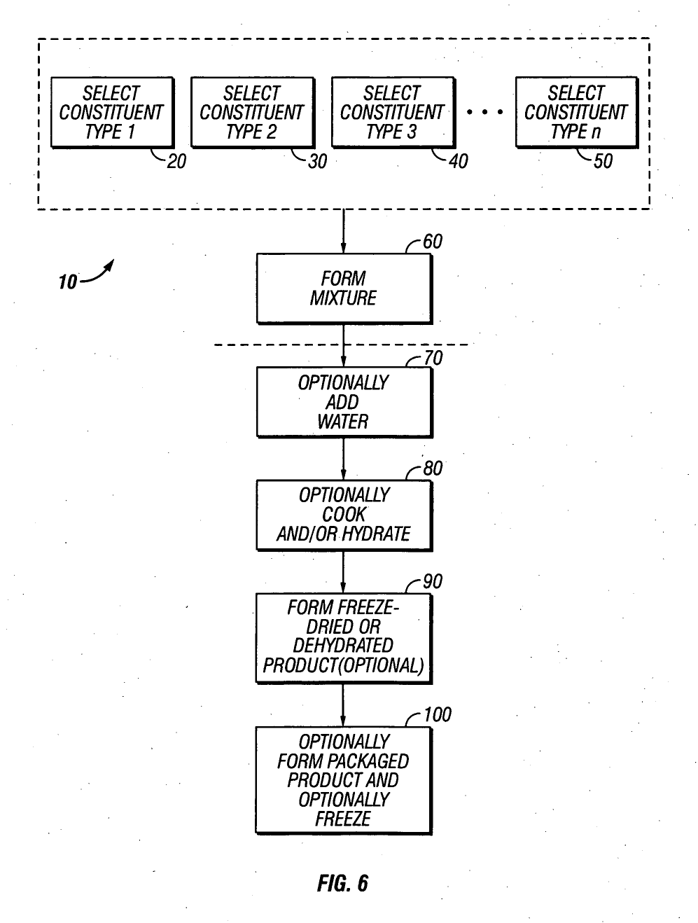

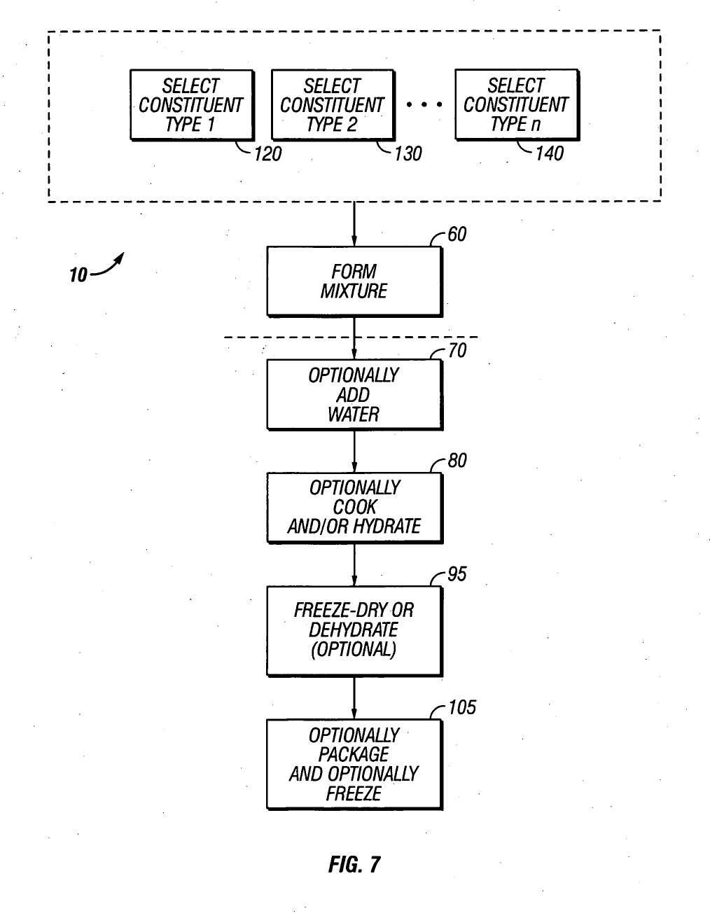

A freeze-dried product or dehydrated product 90 can be formed such as by any suitable methodology or apparatus for freeze-drying or dehydration. In FIG. 6 this is illustrated as a step of freeze-drying or dehydration. This produces a freeze-dried and hydrated food composition. Optionally as indicated in FIGS. 6 and 7, full or partial cooking can be performed in step 80 as well, although it is not required if hydration is performed via a hydration period. Optionally, other ingredients can be added as well. Optionally the product can be packaged, such as in individual serving pouches. Another alternative is to package as a Meal Ready to Eat, or “MRE”. In this way, the food product is packaged in its freeze-dried or dehydrated form such as for use by used by both consumers or for field personnel. Subsequently, the food product can be reconstituted relatively rapidly, such as by adding water or other suitable fluid such as milk, skim milk or juice as desired. The food product can be eaten as a hot or cold (ready-to-eat) cereal and be reconstituted using hot or cold fluids. The fluid can be heated before adding or added at room temperature, then optionally heated with direct heat source (stove, heat tab, etc.) or microwave oven. In one example, the reconstitution can take between 20 and 90 seconds.

Furthermore, other products can be formed of the food product such as grain bars, nutrition bars, candy bars, cereal bars, meal replacement bars, and other snack foods. It also can be used as a food additive or ingredient in other food items due to the reduction and/or elimination of the cooking process (heat and time). Using these methods, the digestion time and time-release benefits remain intact.

Advantageously, for preferred varied digestion rate grain based embodiments of the food product, the particle size is relatively large such as compared to instant grain cereals and other typical heated grain cereals so as to maintain a relatively low glycemic index. In this embodiment, the food product is a hot cereal with plural grain particles (as well as other optional food constituents as discussed herein).

Gelatinization can optionally occur during the cooking or heating steps, such as steps 310 and 80. This refers to the natural starch of at least one constituent part to convert by gelatinization and pasting, and can serve to coat the other constituents of the food product in a plasticized-like viscous liquid film. For example the natural starch of rolled oats converts into gelatinized starch that coats steel cut oats and whole oat groats. This causes the steel cut oats and whole oats to be more easily chewed and/or swallowed. However, if a sufficiently long hydration time is selected, the constituent parts also can be softened to enhance an eating experience.

Likewise, in the preferred embodiment, differing percentages of different constituent parts can be used. For example, one or more grain or seed can be used; likewise various forms of milling or other processing of the grains can be used. In one example, different forms of oats are used, although different grains can be used as well. In the oats-only embodiment, one or more types of rolled, steel cut, bumped oats and groats are used in desired percentages. Rolled oats are digested relatively quickly providing relatively quick time release of energy and nutrition to the user. Steel cut oats are digested at a slower rate and over a medium length of time. Groats are processed via digestion over a longer period of time thus providing extended nutrition and energy. In this example, to consume, a mixture of the constituent parts of different forms of oats are combined with water and hydrated over a period of time. Likewise other food constituents can be added in, such as dried fruit, whole nuts, chocolate, etc. Only a single length of time needs to be used, as the constituent parts are hydrated together in this example

Examples of food products in accordance with the invention will be discussed below. It should be understood that these merely are examples of preferred embodiments, but other combinations of different constituent parts, and preparation procedures also may be used. It should be understood that in the examples that follow, the amounts are provided to show proportionality, and not limitation on the batch size. Any desired batch size can be selected.

### EXAMPLE 1

It should be understood the amounts are provided to show proportionality, and not limitation on the batch size.

A fresh frozen breakfast cereal with fruit is made as follows:

Hydrate (i.e. soak) 50 g of grain and/or seed constituents for 10 to 12 hours (turn over 2 times) in ⅓ cup+1 TBSP (Tablespoon) of water;

Add 1 TSP (Teaspoon) non-fat dry powdered milk and then mix

Add 1 TSP (Teaspoon) honey and then mix;

Add ⅓ cup frozen fruit and then mix; and

Freeze in one or more containers.

Alternatively add the powdered milk, honey and frozen fruit at the same time and then mix, or add different combinations of them followed by mixing. In one embodiment, the grain and/or seed constituents include one or more forms of oats.

### EXAMPLE 2

A fresh frozen soup such as a chili oats with beans and tomato is made as follows:

Hydrate (i.e. soak) 50 g of grain and/or seed constituents for 10 to 12 hours (turn over 2 times) in ⅓ cup+1 TBSP (Tablespoon) of water;

Add 1 TSP (Teaspoon) dry chili powder and then mix;

Add ⅛ TSP (Teaspoon) table salt and then mix;

Add 1 TSP (Teaspoon) honey and then mix;

Add 1 TBSP (Tablespoon) tomato paste and then mix;

Add ⅓ cup rinsed dark red kidney beans (pre-hydrated) and then mix;

Add ⅓ cup tomato sauce and then mix; and

Freeze in one or more containers.

Alternatively add the chili powder, salt, honey, tomato paste, beans and tomato sauce at the same time and then mix, or add different combinations of them followed by mixing. In one embodiment, the grain and/or seed constituents include one or more forms of oats.

### EXAMPLE 3

A fresh frozen soup such as a chicken, oats and vegetable soup is made as follows:

Hydrate 50 g of grain and/or seed constituents for 10 to 12 hours (turn over 2 times) in ⅓ cup+1 TBSP (Tablespoon) of water;

Add ⅓ cup frozen or unfrozen mixed vegetables;

Add ⅛ TSP (Teaspoon) salt;

Add 99% fat free chicken broth as desired, such as 9.5 oz.;

Mix; and

Freeze in one or more containers.

Alternatively mixing can be performed following one or more of the adding steps. In one embodiment, the grain and/or seed constituents include one or more forms of oats.

### EXAMPLE 4

A fresh frozen soup such as beef and vegetables is made as follows:

Hydrate 50 g of grain and/or seed constituents for 10 to 12 hours (turn over 2 times) in ⅓ cup+1 TBSP (Tablespoon) of water;

Add ⅓ cup frozen or unfrozen mixed vegetables;

Add ⅛ TSP (Teaspoon) salt;

Add 99% fat free beef broth as desired such as 9.5 oz.;

Mix; and

Freeze in one or more containers.

Alternatively mixing can be performed following one or more of the adding steps. In one embodiment, the grain and/or seed constituents include one or more forms of oats.

### EXAMPLE 5

A cereal product is formulated as follows:

½ cup of rolled oat flakes
(One half of each mill type: ¼ cup of 0.033″ and ¼ cup of 0.037″ rolled oats)

3 tablespoons of Steel Cut Oat Groats

2 tablespoons of Bumped Oat Groats

2 tablespoons of Whole Oat Groats.

In order to prepare for eating, about 2¼ cups of water can be added to the mixture and the mixture is hydrated for 5-15 hours. The hydrated cereal optionally can be eaten at room temperature or alternatively heated. Also optionally, it can be packaged for further distribution after hydration, such as by freezing and stored in freezable and optionally microwavable containers.

Numerous variations can be practiced. For example, fresh frozen, dried or dehydrated fruit can be pre-packaged with the mixture. Alternatively, it can be added during preparation for eating. For example, ¼ cup of frozen fruit is added. Examples of fruit include raisins and dried or dehydrated cranberries, blueberries, peaches, pineapples, cherries, etc. Nuts can be added as well.

Other variations include adding milk, or sweetener such as natural sweeteners like sugar, syrup or honey, or artificial sweeteners like aspartame, splenda or saccharine.

### EXAMPLE 6

A cereal product is formulated as follows:

½ Cup of rolled oats

3 Tablespoons of whole oat groats

2 Tablespoons of steel cut oats

In order to prepare for eating, about 2 cups of water can be added for a hydration period. Optionally, it could be packaged for further distribution after being hydrated, such as being packaged and optionally frozen. It should be noted that the variations described above with respect to Example 5 apply equally as well to Example 6 and other embodiments as well.

It should be noted that depending on the particular recipe or individual taste other amounts of the different ingredients in the above examples food composition can be used and the above examples are not meant to limit the scope of the invention herein, but only are provided as some of the numerous possibilities. Likewise, the particular brands of ingredients are provided only as examples, and other brands or sources can be used. The amounts are provided only as examples of particular food products that can be prepared, sold, or otherwise packaged and distributed, of a food product incorporating the food composition of the present invention. In addition, hydration as mentioned in the above examples can also be shortened by using partial pre-cooking or steaming, or can be eliminated by pre-cooking. In some embodiments, hydration is not performed, such as when pre-processed dry grain constituents are used—such as cereal flakes.

Continuing with a general description of the invention, an example of a time released food composition in one embodiment provides the constituent part (such as rolled oats) that is digested relatively quickly, typically over about an hour or two in Examples 1 or 2 above. A “medium” release constituent (such as steel cut oats) is digested over a medium amount of time, such as about three to four hours in Examples 1 or 2. A “long” time release constituent (such as whole grain oats, groats etc.) is digested over an extended period, such as about five to eight hours. It should be understood that these time ranges of digestion are an example only to illustrate the short, medium and long time release rates. Actual time release-or digestion rates in different individuals will vary.

In addition, by preserving a high fiber content in the ingredients other benefits are achieved, such as slowing the digestion of other foods eaten after the mixiblend is ingested, due to the absorption properties of the fiber. The high water absorption by the fiber tends to fill the gut without gas bloating and reduces appetite and food consumption as a result.

It should be understood that the food product of the present invention can be used to manage blood glucose response/levels by using a selected blend of time released (i.e. varying rates of digestion) carbohydrates, such as necessary for good nutrition of persons having diabetes. One way of ranking carbohydrate foods on how quickly carbohydrates enter the bloodstream and elevate blood sugar is a glycemic index (GI). Quickly digested and metabolized carbohydrates have the highest glycemic indexes. Their blood sugar or glucose response is fast and high. Slowly digested carbohydrates have low glycemic indexes and release glucose gradually into the bloodstream. Their blood sugar or glucose response is slow and steady.

It is understood that diets with a low glycemic load may be useful in preventing or regulating diabetes and coronary heart disease. In general, refined, starchy foods eaten in the have a relatively high glycemic index. The food composition of the present invention can be selected to provide a low glycemic index, while also being high in fiber (especially viscous fiber), having some starch that resists gelatinization, while also having other starch that gelatinizes, is digested at varying rates, and contains phytonutrients that slow digestion and absorption. When the food composition is eaten, it is understood that one mode benefit is that it provides both a time released carbohydrate AND slows the digestion and glycemic response of high-glycemic foods eaten at the current meal or the next meal eaten at a later time, acting like a fiber sponge that absorbs the shock and delays the release to slow digestion. Not only is the glycemic index affected by other components of a meal, it is also affected by food selections at prior meals. For instance, inclusion of the food composition of the present invention at a preceding meal can act to lower the glycemic index of a carbohydrate food in a later meal. This is called a lente carbohydrate effect. In addition, it is understood that ingestion of a food with either a low or moderate glycemic index prior to exercise improve can improve endurance, a further advantage of the present invention.

Slowly released starches, such as those in some forms of oatmeal, tend to have low glycemic indexes, even if they are fully digested and have been found to be useful to add to the diet of diabetics for regulating blood glucose levels. The larger and more intact the particle size, the lower the glycemic index. Thus, in selecting the constituent parts of the food composition of the present invention it is desired to include at least a portion of constituent(s) that provide a relatively low glycemic index.

It is understood that a reduction in diabetic side effects can be achieved with the regular selection of starchy foods with relatively moderate or low glycemic indices. An example of one such side effect is elevated blood lipid levels. This reduction of diabetic side effects is provided by the food composition of the present invention and in addition, the food composition improves the entire health of an individual's diet by counter balancing the effect of a high-glycemic diet. The health effect is realized by adding the food composition of the present invention to an individual's diet and not necessarily by requiring the individual to restrict the intake of other foods that he or she desires. It is understood that current research has shown low-glycemic index foods such as the food composition of the present invention can provide, results in relatively lower fluctuations in blood sugar levels and improve to the sensitivity to insulin with the ultimate goal of better blood sugar control in people with insulin resistance and diabetes.

Furthermore, the present invention can be used for weight loss, such as a diet supplement, that may be used to lose weight or control obesity. In operation by providing a timed release of nutrients, including carbohydrates or other sources of nutritional energy, it helps prevent the onset of a hungry feeling in an individual. It assists with this appetite control by providing a relatively level, steady blood sugar/glucose supply and filling the gut with fiber to provide a sense of fullness and satisfaction without overeating. Obesity and low intake of fiber amplify the adverse consequences of high-glycemic load. Consumption of the food composition of the present invention adjusted for a low-glycemic index can lower blood lipids in both diabetics and non-diabetics with elevated blood lipids, and can also be useful in weight loss.

The present invention provides a low-glycemic level, very high fiber, high starch resistance, long/slow digestion time, steady and level carbohydrate delivery or availability.

Viewed another way, one cause of weight gain or obesity is overconsumption of food caused by addressing a feeling of hunger (with all the unpleasant side effects of lightheadedness, irritability, lack of energy, etc.) by eating. The food composition of the present invention provides a diet formula or supplement that allows for weight loss, while still feeling full, or at least not feeling hungry. This is achieved at least in part by the time release property of the food composition. One explanation for the overconsumption of food leading to undesirable or undesired weight gain is a difficulty regulating blood glucose/sugar level—such as can result from a low fiber and/or high glycemic index diet. Such a diet results in an increase in blood glucose level soon after eating. A metabolitic reaction is to respond with relatively high discharges of pancreatic insulin into the blood to drive down the blood glucose level down. Insulin stimulates the body's cells to remove sugar from the bloodstream and utilize it. Next, the body responds with the discharge of glucagon. Glucagon has the opposite effect of insulin and acts as a control mechanism when the body produces too much insulin. It is the lag time effect of this process caused by the shock of low fiber, high glycemic foods that crashes the blood sugar below the fast fasting level. Because of the metabolitic reaction to the consumption of high GI foods, many overweight or obese people can feel hungry again shortly after having eaten, resulting in a cycle of overeating.

Moreover, since the pancreas produces both the insulin and glucagon can become diseased or fail from the roller coaster of insulin and glucagons production, resulting in a frequent form of diabetes (Type II).

The food composition of the present invention provides a high fiber, low glycemic food or meal that delivers a slow, level, and steady stream of complex carbohydrates and nutrients to the consumer. This helps the consumer to regulate his or her blood glucose/sugar and get off the hunger “roller coaster”. The present invention thereby allows a desired level of food consumption avoiding a feeling of hunger, while also reducing the desire for further food intake.

Examples 5 and 6 are examples of an oat blend embodiment that can reduce or eliminate a feeling of hunger for an extended period of time, such as for 5-8 hours and has an additional benefit of providing a substantially even, level blood glucose response. This is very useful for people with diabetes and/or obesity. In addition, it is useful for athletes, persons desiring weight loss, and busy/active people that have time to eat one meal, but need it to carry them through for 5 to 8 hours with energy and clarity of thought from steady and level blood glucose.

In another view, the food product can be considered a carbohydrate dosage delivery system that regulates blood glucose levels/response over an approximately 5 to 8 hour period or a more extended period such as for example 3-48 hours, or longer, due to its formulation and servings size (dosage). An example of a use of such a system is for use by diabetics in regulating blood glucose level. Another use is as a type of diet or dieting supplement, which when eaten can reduce a desire to eat by providing an extended or time released carbohydrate (and other nutrition and energy) delivery providing a feeling of fullness over an extended period of time.

Thus, it is seen that a hydrated and then frozen food product, optionally providing differing rates of digestion and nutrition delivery is provided. One skilled in the art will appreciate that the present invention can be practiced by other than the above-described embodiments, which are presented in this description for purposes of illustration and not of limitation. The description and examples set forth in this specification and associated drawings only set forth embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A frozen food composition comprising:
a first constituent part comprising a processed grain or seed; and
a container containing the first constituent part.

2. The frozen food composition of claim 1 wherein the first constituent part is hydrated and uncooked.

3. The frozen food composition of claim 2 further comprising fresh frozen fruit.

4. The frozen food composition of claim 1 wherein the first constituent part is partially cooked, and is hydrated.

5. The frozen food composition of claim 1 wherein the first constituent part is cooked and comprises a gelatinized starch composition coating at least one of the constituent parts.

6. The frozen food composition of claim 1 wherein the container is a microwavable container.

7. The frozen food composition of claim 2 further comprising a hydrated uncooked second constituent part comprising a processed grain or seed.

8. The food composition of claim 7 further comprising at least one additional hydrated constituent part in a mixture with the other constituent parts.

9. The food composition of claim 7 wherein the second constituent part includes rolled oats.

10. The food composition of claim 7 wherein:
the first constituent part has a first nutrition delivery rate;
the second constituent part has a second nutrition delivery rate; and
the second nutrition delivery rate is shorter than the first nutrition delivery rate.

11. The frozen food composition of claim 1 further comprising one or more hydrated partially cooked additional constituent parts.

12. A carbohydrate dosage delivery system for use in regulating blood glucose levels over an extended period of time comprising the frozen food composition as recited in claim 2.

13. A method of manufacturing a food composition comprising:
forming constituent parts;
adding fluid to the constituent parts and waiting during a hydration period a sufficient period to hydrate the constituent parts;
freezing.

14. The method of manufacturing a food composition of claim 13 wherein the hydration period is performed without the addition of heat.

15. The method of manufacturing a food composition of claim 13 wherein the hydration period includes cooking or partial cooking of all or a portion of the constituent parts.

16. The method of manufacturing a food composition of claim 13 wherein forming the constituent parts includes:
selecting a first constituent part having a first nutrition delivery rate when hydrated; and
selecting a second constituent part having a second nutrition delivery rate when hydrated.

17. The method of manufacturing a food composition of claim 16 wherein forming the constituent parts further includes mixing the first and second constituent parts.

18. The method of manufacturing a food composition of claim 13 further comprising mixing after adding fluid.

19. The method of manufacturing a food composition of claim 13 further comprising adding fluid ingredients during the hydration period.

20. The method of manufacturing a food composition of claim 13 further comprising adding solid ingredients during the hydration period.

21. The method of manufacturing a food composition of claim 13 further comprising adding additional ingredients prior to freezing.

22. The method of manufacturing a food composition of claim 13 comprising adding fruit prior to freezing.

23. The method of manufacturing a food composition of claim 13 further comprising packaging before freezing.

24. The method of manufacturing a food composition of claim 23 wherein packaging includes positioning the hydrated food product in an individual serving container.
